(19) United States
(12) Patent Application Publication
(10) Pub. No.: US 2007/0108660 A1
(43) Pub. Date: May 17, 2007

(54) MULTI-STEP ROTATIONAL MOLDING PROCESS AND DURABLE COMPONENT ARTICLES THEREFROM

(76) Inventor: Kathleen A. Anderson, Des Plaines, IL (US)

Correspondence Address: WELSH & KATZ, LTD, 120 S RIVERSIDE PLAZA, 22ND FLOOR, CHICAGO, IL, 60606, US

(21) Appl. No.: 11/620,279

(22) Filed: Jan. 5, 2007

Related U.S. Application Data
(62) Division of application No. 11/038,847, filed on Jan. 19, 2005.
(60) Provisional application No. 60/538,301, filed on Jan. 22, 2004.

(51) Int. Cl. B28B 1/14

(52) U.S. Cl. 264/308; 264/310

(57) ABSTRACT

The present invention provides a process for manufacturing durable components such as doll components. The process is a multi-step rotational molding process using a plasticized polyvinyl chloride-based thermoelastic polymer outer layer that is relatively is soft and has a durometer value of about 10 to about 30 on a Shore A scale, and a more rigid inner layer that is a plasticized polyvinyl chloride-based thermoelastic polymer having a durometer value of greater than 20 to about 45 on a Shore A scale.

### CROSS-REFERENCE TO RELATED APPLICATION

This application claim priority from provisional application Ser. No. 60/538,301 filed Jan. 22, 2004.

### BACKGROUND OF THE INVENTION

Rotational molding processes are useful for making hollow polymeric molded articles that have a high level of detail. The rotation permits delicate features of the mold to be filled in with the polymeric formulation. The present invention is primarily concerned with the making of components for soft, detailed articles, such as dolls.

Rotational molding of doll components has been used in the art with a range of thermoplastic polymers. In some cases, the polymers are polyamide-based and tend to have a smooth plastic look and feel.

One drawback to the use of silicone for making doll or other components is that the articles formed therefrom tend to attract dust and dirt. The dust and dirt migrates into the surface of the article, making it appear dirty. It is very difficult to remove the dust particles.

In summary, there is a need in the art for a method of constructing a durable article such as a doll with soft-touch skin that has improved longevity and durability.

### BRIEF SUMMARY OF THE INVENTION

The present invention provides a process for preparing molded articles having at least an inner and an outer layer, and whose exterior surfaces have the soft touch of human skin. Another process utilizes only a single layer and also results in a durable molded component whose exterior surfaces have the soft touch of human skin. Articles made from such a process are also contemplated; i.e., durable articles. The invention is illustrated by the preparation of durable articles that are components of dolls, but can also be used to prepare other durable articles such as the outer portions of artificial limbs, toys other than dolls and the like.

One process comprises a rotational molding process in which the article's soft outer layer is first formed against the inner surface of a rotating mold cavity, and then at least one other more rigid layers is formed on the inner surface of that soft outer layer. The soft outer layer comprises a soft polymer that has a durometer value of about 10 to about 30, and preferably about 10 to about 20, on a Shore A scale at ambient temperature (about 20° C.). The inner layer comprises a more rigid polymer that has a higher durometer value and is greater than 20 to about 45, and preferably greater than 20 to about 35, on a Shore A scale at ambient temperature (about 20° C.).

In one preferred embodiment, both the soft outer layer and the more rigid inner layer comprise a polyvinyl chloride-based thermoelastic polymer mixture, preferably also including silicone oil. This preferred embodiment provides a product with a soft outer surface that has a velvety, mildly tacky tactile sensation resembling human skin that is unique for a PVC plastic doll component.

The softness of the soft outer layer is achieved largely through use of a high proportion of plasticizer in the polymer mixture, about 45 to about 65 weight percent of the polymer mixture for the soft outer layer. The increased rigidity of a rigid inner layer is achieved largely through use of a lower proportion of plasticizer in the polymer mixture, about 10 to about 30 weight percent of the inner layer polymer mixture.

A preferred article such as a doll component has two layers. Each layer is itself about 1 mm to about 10 mm thick, preferably each layer is about 1 mm to about 5 mm thick, and most preferably each layer is about 1 mm to about 3 mm thick. These thicknesses for each layer provide a doll component about 2 to about 20 mm thick, preferably about 2 to about 10 mm thick, most preferably about 2 mm to about 6 mm thick.

The presence of one or more additional optional layers outside (upon the soft layer) or between the soft outer layer and the more rigid inner layer is contemplated to be within the spirit of the present invention. Preferably, such layers are very thin, less than 2 mm. For example, one such additional outer layer can be a layer including coloration or coloring details as can be painted on after rotomolding, or the additional layer can be tint, color-changing, sparkle or high gloss details on the soft outer layer that were pre-loaded into the rotomold or applied after molding. Another example of an additional layer is a layer between the soft outer layer and rigid inner layer, preferably such additional layer imparts some property, such as improved adhesion between the layers or to bond a responsive pad or electric components.

In one contemplated embodiment of a rotational molding process, a rotational mold for a doll component is provided. That mold has one or more interior structures that define a mold cavity and one or more interior surfaces features that define the shape of the molded doll component. A doll component outer layer mixture is introduced into a mold cavity in liquid form and in an amount sufficient to coat the one or more interior surfaces. The out layer is typically provided in an amount that is less than an amount sufficient to completely fill the mold cavity. If the mold cavity is filled, a portion of the liquid outer layer is removed prior to the addition of the inner layer mixture discussed below. The outer layer is relatively soft at ambient temperature (about 20° C.), and has a durometer value of about 10 to about 30, and preferably about 10 to about 20, on a Shore A scale. In one preferred embodiment, that outer layer mixture comprises: (i) about 30 to about 50 weight percent of a first curable polyvinyl chloride-based thermoelastic polymer starting material, and (ii) about 45 to about 65 weight percent, and preferably about 50 to about 60 weight percent, first plasticizer.

The mold is rotated at a speed sufficient to coat the one or more interior surfaces for a time period and at a temperature sufficient to permit at least partial solidification of the outer layer mixture to form an at least partially-cured (-solidified) molded outer layer having an outer surface in contact with the one or more interior surfaces. The at least partial cure of the outer layer mixture is sufficient to retain the shape of the molded doll component and to define an interior surface of the at least partially-solidified molded outer layer. Cure (solidification) of the polymer outer layer mixture is typically initiated, by cooling the outer layer mixture.

A liquid inner layer mixture is introduced to the interior surface of the at least partially-solidified molded outer layer in the mold. The liquid inner layer mixture liquid is present in an amount sufficient to coat the interior surface of the at least partially-solidified molded outer layer of the molded doll component. When cooled to ambient temperature (about 20° C.), the inner layer is relatively rigid and has a durometer value of greater than 20 to about 45, and preferably greater than 20 to about 35, on a Shore A scale. The inner layer thus has a smaller durometer value than does the outer layer. In one preferred embodiment, the inner layer component mixture comprises: (i) about 30 to about 60 weight percent of a second curable polyvinyl chloride-based thermoelastic polymer starting material, and (ii) plasticizer in the polymer mixture about 10 to about 30 weight percent, and preferably about 15 to about 25 weight percent of a second plasticizer.

The mold is rotated for a time period and at a temperature sufficient to permit at least partial curing (solidification) of the inner layer forming a durable component such as a molded doll component having an inner layer and an outer layer. The phrase “at least partial curing” and similar phrases are used herein to mean that at least enough solidification has occurred so that addition of another molten layer does not melt features on the exterior of the casting. Cure (solidification) of the polymer inner layer mixture is initiated as discussed before.

It is noted that in each instance in which solidification (cure) is initiated and the mold is rotated, initiation of solidification can follow the beginning of rotation or vice versa. The cure of either or both of the inner layer and outer layer can be completed within or outside of the mold, although it is often more convenient to complete the cure (solidification) with the durable component within a mold cavity.

It is also noted that once cured, the durable components are preferably hollow so that neither the first nor the second thermoelastic polymer starting material fills the cavity of the mold or that formed after the first layer has been at least partially cured. Although some portions of a component such as the fingers or toes of a doll can be solid, a preferred durable component is nonetheless generally hollow.

A process for manufacturing a molded durable component having a single layer is also contemplated. This process comprises the steps of providing a rotational mold for a durable component. The mold has one or more interior surfaces that define a mold cavity, and an outside. The one or more interior surfaces of the mold have features that define the shape of the molded durable component. A liquid mixture is introduced into the mold cavity in an amount sufficient to coat the one or more interior surfaces. The liquid mixture comprises a polyvinyl chloride-based thermoelastic polymer and a plasticizer. The mixture has a durometer value of about 10 to about 45 on a Shore A scale at ambient temperature after solidification. The mold is rotated at a speed sufficient to coat the one or more interior mold surfaces for a time period and at a temperature sufficient to permit at least partial solidification of the mixture to form an at least partially-solidified molded durable component having an outer surface in contact with the one or more interior surfaces of the mold. The at least partial solidification is sufficient to retain the shape of the molded durable component and to define an interior surface of the at least partially-solidified mixture, thereby forming a molded durable component.

The present invention has many benefits and advantages, several of which are listed below.

One advantage of a preferred embodiment of the invention is that the durable components manufactured by the present method have a nice smell, color and translucence in addition to the durability and soft feel of human skin.

One benefit of the invention is that the process permits manufacture of durable components.

Another advantage of the invention is that the durable components made from such a process are long lasting and aesthetically pleasing.

Another benefit of the process is that the components manufactured using the process can have a soft, velvety feel and dewy look.

Still further benefits and advantages of the invention will be apparent to the skilled worker from the discussion that follows.

### DETAILED DESCRIPTION OF THE INVENTION

The present invention contemplates a process for molding a durable article (or component) whose exterior surface has the soft touch of human skin such as doll components, and the articles made from such a process. One process utilizes a rotational molding process where a soft outer layer is formed and at least one other more rigid layer is formed inside the soft outer layer. The soft outer layer is formed using a soft polymer to provide a soft outer layer that has a durometer value of about 10 to about 20 on a Shore A scale at ambient temperature, about 20° C. The more rigid inner layer is formed inside the soft outer layer to provide a layer that has a durometer value of more than about 20 to about 35 on a Shore A scale at ambient temperature. The relatively more rigid inner layer has a higher durometer value than does the relatively soft outer layer. Preferably the more rigid inner layer comprises a polymer that bonds to the soft outer layer.

Typically, the polymer is plastic and the inner layer is made from the same type of plastic as the outer layer. The inner layer mixture typically has less plasticizer than was used in the outer layer mixture in order to provide the increased rigidity to the inner layer.

More specifically, the invention contemplates a process for manufacturing a molded durable component having an inner layer and an outer layer. The process comprises the steps of:

(a) providing a rotational mold for a durable component. The mold has one or more interior surfaces that define a mold cavity, and an outside. The one or more interior surfaces have features that define the shape of the molded durable component.

(b) An outer layer mixture in liquid form is introduced into the mold cavity. The outer layer mixture is present in an amount sufficient to coat the one or more interior surfaces, and comprises a first polyvinyl chloride-based thermoelastic polymer starting material, and a first plasticizer. The outer layer mixture has a durometer value of about 10 to about 30, and preferably about 10 to about 20, on a Shore A scale at ambient temperature.

(c) The mold is rotated at a speed sufficient to coat the one or more interior mold surfaces for a time period and at a temperature sufficient to permit at least partial solidification of the outer layer mixture to form an at least partially-solidified molded outer layer having an outer surface in contact with the one or more interior surfaces of the mold. The at least partial solidification is sufficient to retain the shape of the molded durable component and to define an interior surface of the at least partially-solidified outer layer.

(d) A liquid inner layer mixture is introduced into the interior surface of the at least partially-solidified molded outer layer in the mold. The liquid inner layer mixture is present in an amount sufficient to coat the interior surface of the at least partially-solidified molded outer layer of the molded durable component and comprises a second polyvinyl chloride-based thermoelastic polymer starting material, and a second plasticizer. The inner layer mixture has a durometer value of more than about 20 to about 45, and preferably more than about 20 to about 35, on a Shore A scale at ambient temperature.

(e) The mold is rotated for a time period and at a temperature sufficient to permit at least partial solidification of the inner layer mixture, forming a molded durable component having an inner layer and an outer layer.

Thus, in preferred processes, both layers are illustratively polyvinyl chloride (PVC), however, other polymer/plasticizer combination that can provide the desired Shore A hardness value can be used.

The soft outer layer is about 1 mm to about 15 mm thick, preferably about 1 mm to about 5 mm thick. A PVC such as the emulsion-polymerized product sold under the designation PR-415 by Thai Plastics Co. of Thailand is preferably utilized for the outer layer. This PVC has a degree of polymerization of about 1000±50 and is provided in the form of a very fine powder whose individual grains are not readily felt, and has a density of about 0.25 g/cc. The softness of the soft outer layer is achieved largely through use of a high proportion of plasticizer in the polymer mixture, about 45 to about 65 weight percent, preferably about 50 to about 60 weight percent, most preferably about 55 weight percent of the polymer mixture for the soft outer layer.

A more rigid inner layer is about 1 mm to about 15 mm thick, preferably about 1 mm to about 5 mm thick. This layer illustratively utilizes the above emulsion-polymerized PVC PR-415 from Thai Plastics Co. along with a suspension-polymerized PVC sold under the designation PR-D by Vinnolit GMBH of Germany. This latter powdered polymer has a larger grain size of about 50μ whose particulate nature can be felt, a density of about 50 g/cc and a degree of polymerization of about 1000±50. The increased rigidity of a rigid inner layer is achieved largely through use of a lower proportion of plasticizer in the polymer mixture about 10 to about 30 weight percent, preferably about 15 to about 25 weight percent, most preferably about 20 weight percent of the inner layer polymer mixture.

In one embodiment, the plasticizer is a phthalate diester, preferably a di-C₇ to C₁₂ alkanyl phthalate. The di-C₇ to C₁₂ alkanyl phthalate is preferably di-C₇ to C₁₀ alkanyl, most preferably di-C₉ alkanyl such as di-iso-nonyl phthalate. The di-C₇ to C₁₂ alkanyl phthalate can be obtained commercially, or the di-ester can be made from readily available phthalic anhydride and the corresponding C₇ to C₁₂ straight or branched chain alkyl alcohol. A trans esterification reaction can also be used between commercially available dimethyl or diethyl phthalate and the corresponding C₇ to C₁₂ straight or branched chain alkyl alcohol using an acidic catalyst.

In a preferred embodiment, there are two layers, although more layers are also contemplated. Each layer is itself about 1 mm to about 10 mm thick, preferably where each layer is about 1 mm to about 5 mm thick, most preferably where each layer is about 1 mm to about 3 mm thick) provide a durable component such as a doll component about 2 to about 20 mm thick, preferably about 2 to about 10 mm thick, most preferably about 2 mm to about 6 mm thick.

In a preferred embodiment, the inner layer that provides more rigidity to the fabricated durable component bonds intimately with the soft outer layer. Preferably, the inner, more rigid layer is introduced and spun in the rotational mold before the outer layer is fully hardened. The effect is a slight mixing between the layers with improved integration of the two polymer layers.

In some preferred embodiments, the soft outer layer is formed using a polyvinyl chloride-based thermoelastic polymer mixture that optionally includes silicone oil (about 500 to about 3000 cs), and a plasticizer such as a di-C₇ to C₁₂ alkanyl phthalate. The polyvinyl chloride of the polyvinyl chloride-based thermoelastic polymer mixture outer layer comprises about 30 to about 50 weight percent, preferably about 35 to about 45 weight percent, most preferably about 40 percent of the polyvinyl chloride-based thermoelastic polymer mixture. Silicone oil, when present, constitutes about 0.1 to about 5 weight percent, preferably about 0.5 to about 2 weight percent and most preferably about 1 weight percent of the polyvinyl chloride-based thermoelastic polymer mixture in which it is present.

The di-C₇ to C₁₂ alkanyl phthalate as described before constitutes about 45 to about 65 weight percent, preferably about 50 to about 60 weight percent, most preferably about 55 weight percent of the polyvinyl chloride-based thermoelastic polymer mixture. The di-C₇ to C₁₂ alkanyl phthalate is preferably C₇ to C₁₀ alkanyl, most preferably C₉ alkanyl, e.g., nonyl, and more preferably is iso-nonyl. This outer layer has tactile qualities that provide a soft velvety feeling to the surface of a doll's “skin”.

A more rigid inner layer is then formed using the same, a different polyvinyl chloride polymer or a mixture of two or more such polymers in the polyvinyl chloride-based thermoelastic polymer mixture. At ambient temperature, this layer is more rigid than the first, outer layer. The more rigid layer includes a polyvinyl chloride-based thermoelastic polymer mixture, a di-C₇ to C₁₂ alkanyl phthalate, an optional silicone oil (so that the silicone oil can be present in one or both of the layers), and can further include an additional PVC polymer that acts as a viscosity depressant as well as an additional plasticizer.

For this inner, relatively more rigid layer, the first polyvinyl chloride starting material, e.g., the above PVC PR-415, makes up about 30 to about 60 weight percent, preferably 35 to 50 weight percent, most preferably about 45 percent of the polyvinyl chloride-based thermoelastic polymer mixture. The second PVC starting material, e.g., PR-D, is present at about 20 to about 30 weight percent, and more preferably about 20 to about 25 weight percent, and most preferably about 23 weight percent. Including both types of resin, the PVC resin constitutes about 50 to about 80 weight percent, and more preferably about 55 to about 75 weight percent and most preferably about 65 to about 70 weight percent of the relatively more rigid inner layer polyvinyl chloride-based polymer mixture.

The di-C₇ to C₁₂ alkanyl phthalate plasticizer is present at about 15 to about 25 weight percent, preferably about 15 to about 20 weight percent, most preferably about 18 weight percent of the inner layer thermoelastic polymer mixture. The additional plasticizer is present at about 5 to about 15 weight percent, preferably about 5 to about 10 weight percent, most preferably about 8 weight percent of the inner layer thermoelastic polymer mixture. An illustrative additional plasticizer is a material sold under the designation MAX-909 available from Golden Chemical Corp. that is a mixture of di-iso-nonyl adipate and butyl oleate. A product available from Eastman Chemical Co. sold under the designation TXIB (2,2,4-trimethyl-1,3-pentanediol diisobutyrate) can be used in place of the MAX-909 product. The total of these two plasticizers is then about 20 to about 40 weight percent, more preferably about 20 to about 35 weight percent and most preferably about 26 weight percent of the relatively more rigid inner layer polyvinyl chloride-based polymer mixture.

In some embodiments, the polymer mixtures further include silicone oil in one or both of the soft outer layer and the more rigid inner layer. In a preferred embodiment, the polyvinyl chloride-based thermoelastic polymer mixture includes silicone oil (about 500 to about 3000 cs), most preferably in both the soft outer layer and the more rigid inner layer. In this embodiment, the soft outer layer includes silicone oil at about 0.1 to about 5 weight percent, preferably about 0.5 to about 2 weight percent and most preferably about 1 weight percent of the outer layer thermoelastic polymer mixture. The more rigid inner layer polymer mixture further includes silicone oil at about 0.5 to about 5 weight percent, preferably about 0.5 to about 2 weight percent and most preferably about 1 weight percent in the inner layer thermoelastic polymer mixture.

A process for manufacturing a molded durable component having a single layer is also contemplated. A preferred process comprises the steps of a) providing a rotational mold for a durable component, the mold having one or more interior surfaces defining a mold cavity, and an outside. The one or more interior surfaces of the mold have features that define the shape of the molded durable component. A layer mixture is introduced in liquid form into the mold cavity (b), the layer mixture being present in an amount sufficient to coat the one or more interior surfaces. The layer mixture comprises a polyvinyl chloride-based thermoelastic polymer, and a plasticizer. The layer mixture has a durometer value of about 10 to about 45 on a Shore A scale at ambient temperature after solidification. The mold is rotated at a speed sufficient to coat the one or more interior mold surfaces for a time period and at a temperature sufficient to permit at least partial solidification of the layer mixture to form an at least partially-solidified molded layer having an outer surface in contact with the one or more interior surfaces of the mold. That at least partial solidification is sufficient to retain the shape of the molded durable component and to define an interior surface of the at least partially-solidified layer thereby forming a molded durable component.

Following the teachings discussed elsewhere herein, the polyvinyl chloride-based thermoelastic polymer starting material comprises about 30 to about 80 weight percent and the plasticizer comprises about 20 to about 65 weight percent of said layer. Within these ranges, one can achieve a desired durometer value for the component at ambient temperature. The plasticizer used here is preferably a previously discussed di-C₇ to C₁₂ alkanyl phthalate. A silicone oil of about 500 to about 3000 cs is preferably present in the layer and constitutes about 0.1 to about 5 weight percent of said layer. In preferred single layer embodiments, the previously discussed relatively softer outer layer composition of the two layer components is utilized. A durable component prepared using this rotational casting method or a simple casting method wherein the desired components are melted together, mixed to substantial homogeneity and poured into a mold is also contemplated. The additional components discussed elsewhere herein can also be present in the component and used in a process of preparing that component.

Stabilizers can and preferably are also used in a contemplated polyvinyl chloride-based polymer mixture used for any layer. These materials such as epoxidized soya oil, divalent metal (e.g. calcium, barium, zinc and cadmium) compounds such as stabilizer CZ-740 or CZ-340 available from Golden Chemical Co. and organo tin compounds help prevent discoloration during processing of the polyvinyl chloride-based polymer mixture. These stabilizers are typically used in combination and each in minor amounts up to a total of about 7 percent by weight of the polyvinyl chloride-based polymer mixture for any layer.

One particularly preferred method for manufacturing a durable component that has a soft outer layer and a more rigid inner layer contemplates the provision of a rotational mold for a durable component having an inside and an outside. A mold containing a molten polyvinyl chloride-based thermoelastic polymer outer layer mixture is provided. The mold has one or more interior surfaces with features that define the shape of the molded durable component and define a mold cavity. Initially, the soft outer layer polymer mixture (starting material) includes (i) about 30 to about 50 (preferably about 35 to about 45, most preferably about 40) weight percent polyvinyl chloride polymer starting material; (ii) about 0.1 to about 5 (preferably about 0.5 to about 2, most preferably about 1) weight percent silicone oil; and (iii) about 45 to about 65 (preferably about 50 to about 60, most preferably about 55) weight percent di-C₇ to C₁₂ alkanyl phthalate. The di-C₇ to C₁₂ alkanyl phthalate is preferably C₈ to C₁₀ alkanyl, most preferably C₉ alkanyl. The mold is heated, rotated and cooled for a time period sufficient to permit the initiation of curing (solidification) of the molten outer layer mixture in order to provide an at least partially-solidified (cured) molded outer layer and to define an interior surface of the at least partially-cured molded outer layer.

In the interior of the at least partially-solidified, molded outer layer of the durable component within the mold, a molten polyvinyl chloride-based thermoelastic polymer inner layer mixture is introduced that initially comprises (i) about 30 to about 60 (preferably about 30 to about 50, most preferably about 45) weight percent polyvinyl chloride polymer starting material such as the emulsion-polymerized PVC designated PR-415; (ii) about 0.5 to about 5 (preferably about 0.5 to about 2, most preferably about 1) weight percent silicone oil; (iii) about 15 to about 30 (preferably about 15 to about 25, most preferably about 20) weight percent di-C₇ to C₁₂ alkanyl phthalate; and preferably further includes (iv) about 20 to about 30 (preferably about 20 to about 25, most preferably about 23) weight percent of a second PVC such as the suspension-polymerized material designated PR-D that acts as a viscosity depressant; and also preferably further includes (v) about 5 to about 15 (preferably about 5 to about 10, most preferably about 8) weight percent additional plasticizer. The mold is heated, rotated and cooled for a time period sufficient to permit the thermoelastic polymer inner layer to be distributed, to initiate curing (solidification) of the inner layer within the molded outer layer, thereby forming a molded, at least partially-cured doll component. The interior surface of the at least partially-cured, molded inner layer is also thereby defined. The heating, rotating and cooling of the mold is terminated separately or together, producing the molded durable component.

Doll components. It is common in the manufacture of the type of dolls of primary interest herein, to manufacture dolls from various components, assembled together. Doll components typically include a head with an integrated neck, a body, integrated arm-hand components, and integrated leg-foot components. Several embodiments of dolls are manufactured from doll components produced according to the methods of the present invention. In preferred embodiments, one or more of the doll components are manufactured according to a process of the present invention, such as the head, arm, hand, leg, foot and torso components of a doll. Construction of a doll is contemplated wherein components manufactured according the processes disclosed herein are combined with traditionally constructed components. This is discussed further hereinbelow.

In preferred embodiments, the aesthetic properties of the manufactured doll components are enhanced using scents and pigments already known in the doll manufacturing arts. The polymeric material used in manufacturing a durable component as can be used in a doll according to the present invention does not itself have a disagreeable odor. Common fragrances include a baby powder, almond, vanilla, cinnamon, sandalwood, fruity scents such as fresh citrus, banana, strawberry, melon blueberry apple, green apple, and flowery scents such as lilac, freesia, and rose. In a preferred embodiment fragrance is added to the polymer mixture prior to molding of the article. The invention contemplates use of fragrance in an inner or an outer layer, or both. In a preferred embodiment, fragrance is in the outer layer or both layers, outer layer is preferred.

The polymeric material used in manufacturing a doll component typically has a natural translucent color. In preferred embodiments, pigment is used to provide skin color to the doll. In a particularly preferred embodiment, pigment is added to the polymer mixture prior to molding of the article. The invention contemplates use of pigmentation in the inner or the outer layer, or both. In a preferred embodiment, pigment is in the outer layer or multiple layers.

Preferably, scent and pigment are included in the soft outer layer. Optionally, scent and pigment, although not necessarily in the same proportions, are also included in the more rigid inner layer. For example, for baby dolls, perfume such as baby powder scent is used.

In one embodiment, the body of the doll is a soft body with a fabric outer layer and stuffing. The invention contemplates using the materials and methods known in the art in conjunction with one or more of the head, arm and leg components made in accordance with a contemplated process.

The doll body optionally houses mechanisms for sound components, recorders or responsive elements. Responsive elements do something in response to a stimulus, such as make the baby laugh when it is picked up, or speak certain phrases in response to the doll a person's voice. These optional sound components, recorders and responsive elements are known in the art and need not be further explicated herein.

Dolls are contemplated that are made up of various combinations of components, where one or more doll component made according to the present invention are combined with components made as is known in the art. The following examples of contemplated combinations are merely illustrative and not intended to limit the permutations of contemplated component combinations. In one embodiment, the doll head is fabricated according to the present invention, and the remainder of the doll is made by methods known in the art. In another embodiment, the doll head, hands and feet are made according to the present invention and the remainder of the doll is made by methods known in the art. In another embodiment, the doll head, hands and leg/foot components are made according to the present invention and the remainder of the doll is made by methods known in the art. In another embodiment, the doll head, arm/hand and foot components are made according to the present invention and the remainder of the doll is made by methods known in the art. In another embodiment, the body (torso) and doll head are made according to the present invention and the remainder of the doll is made by methods known in the art. In another embodiment, the doll head, arm/hand and leg/foot components are made according to the present invention and the remainder of the doll is made by methods known in the art. In still another embodiment, the body of the doll is manufactured according to the present invention as a single unit integrated with arms, hands, legs and feet; and the head component, preferably made according to the present invention, is attached separately. In yet another embodiment, the entire doll (head, neck, body, arms, legs, hands and feet) is molded as a single, integrated unit according to the present invention. Contemplated methods of the art include cloth construction, preferably with stuffing. Stuffing known in the art includes, inter alia, polymer pellets, sand and batting.

In some embodiments, the arm or leg components include armature for controlled flexion or maintenance of a position (a posable doll). Doll components manufactured according to the present invention have improved durability upon flexing, as occurs with the use of armature. Armature known in the art includes, inter alia, hinge joints and flexible wire.

In other embodiments, the arms or legs are manufactured using a process of the invention. As with the head, the softer first layer is spun in the rotational mold, followed by the more rigid inner layer. In a preferred embodiment, the arm and hand are integrated in a single, molded piece. In a separate preferred embodiment, the leg and foot are integrated in a single, molded piece. In a preferred embodiment, features such as fingernail or toenails are molded product into the doll component and preferably are then realistically painted.

Also contemplated is variation in the tint of the polymeric mixture in the mold at the beginning of formation of the outer layer of the doll component, resulting in a variably-tinted article. For example with lighter-tinted nail beds, lighter-tinted palms of hands or lighter-tinted soles of feet. In a preferred embodiment using variable tinting, features are also finished after formation of the molded article through additional surface painting. Such a process can be a multi-step process where a differently-tinted polymeric mixture having a composition as described herein for the soft outer layer is applied to the desired features in the mold, followed by application of the main tinted soft outer polymer mixture. Preferably, the solidification of the initial, differently-tinted layer is thermally initiated, but not necessarily permitted to go to completion, prior to application of the main soft outer polymer mixture. Such a process then has more than two molding steps.

Painting of the molded doll components. Due to the nature of the polymer from which the article is formed, certain paint formulations bond best to the molded doll components. Typical, commercially available acrylic paints may flake off the formed article. This effect is exacerbated by the flexible nature of the molded article. Therefore, for the permanent coloration of the molded doll components, a silicone-blended paint is preferred.

Connecting of the molded doll components. Due to the nature of the polymer from which the doll component is molded, certain glue formulations bond best to the molded doll components. Typical, commercially available epoxy resin glues tend to peel off the formed article. This effect is exacerbated by the flexible nature of the molded article. Therefore, for the permanent attachment of the molded doll components, a silicone-blended glue is preferred.

Hair. The present invention contemplates use of the techniques known in the doll-making arts for apply hair and other such details in conjunction with doll components molded according to the invention. Due to the nature of the mixture from which the doll component is molded, certain glue formulations that bond best to the molded doll components are preferred when bonding of hair or other details.

In some embodiments, hair features are molded as part of the head component. In such cases, painting or molded-in pigmentation may be used to color the hair area differently from the skin. In other embodiments, hair is applied as a wig, or in tufts, strands or locks inserted into the “scalp” of the molded head component. In some wig or inserted hair embodiments, the hair area may be colored differently than the skin to enhance the full appearance of the hair. In one embodiment, eyelashes are painted on, or artificial eyelashes are inserted or glued onto the eyelid rim of the head component.

In some embodiments, eye components made by methods known in the art are used in conjunction with head components made according to a process of the present invention. For example, fixed or moveable glass or plastic eyes are attached to a molded doll head, with or without eyelashes. In a preferred realistic embodiment, whether an eye component of the art is used depends upon the model of the doll.

In a preferred embodiment, the scalp has the same pigmentation as the rest of the skin, and hair in tufts, strands or locks are inserted into the scalp of the head component and glued in place.

The present invention provides a process for manufacturing durable doll components and dolls with soft-touch skin. In a preferred embodiment of the process for preparing a durable component such as a doll component, a rotational mold for a doll component is provided containing a polyvinyl chloride-based thermoelastic polymer outer layer mixture that includes about 40 weight percent polyvinyl chloride, about 55 weight percent di-C₉-alkanyl phthalate, about 1 weight percent epoxidized soybean oil; about 2 weight percent stabilizer; about 0.6 weight percent silicone oil; and about 0.2 weight percent pigment. The mold is rotated and heated for approximately 6 minutes, then cooled to provide solidification, before adding the molten polyvinyl chloride-based thermoelastic polymer inner layer mixture that includes about 45 weight percent polyvinyl chloride, about 25 weight percent viscosity depressant, about 20 weight percent di-C₉-alkanyl phthalate, about 2 weight percent epoxidized soybean oil, about 2 weight percent stabilizer, about 1 weight percent silicone oil, about 8 weight percent plasticizer, and less than about 0.1 weight percent pigment. Perfume is optionally further included in the outer layer at about 1 weight percent, and can also optionally be present in the inner layer, but the outer layer is preferred.

The following examples of the invention are provided to explain in detail applications of selected embodiments of the invention, and are not intended to be limiting.

### EXAMPLE 1

### Manufacture of a Baby Doll Head

A baby doll head was formed in a rotational molding process as follows. A multiple-part rotational mold bearing features of a new-born baby was charged with a portion of the following mixture to form a soft outer layer. The percentages listed below are weight percent.

Polyvinyl chloride 125 kg (Emulsion-polymerized resin
PR-415 Formosa Plastics Corp., Taiwan) (38.7%)

Di-isononyl phthalate 181 kg (I.N.P. Union Petrochemicals Co., Ltd., Taiwan; Formosa Plastics Corp., Taiwan) (56.1%)

Epoxidized soybean oil 4 kg (GL-22, Golden Chemical Corp., Taiwan) (1%)

Stabilizer 7 kg (CZ-740 Golden Chemical Corp, Taiwan) (2%)

Silicone oil 2 kg (1000 cs, Wacker, Germany) (0.6%)

Perfume 3.2 kg (Perfumery, China) 1%

Pigment 500 g (PasterFC-5, Huntsman, USA; Red-B, Clariant, Germany; Y-37, Blue-B, R-CR2, Bayer, U.K.;

Carbon Black #3500, Columbia Co. Ltd. USA) (0.2%) (322.7 kg total) (99.6% total)

The mold was rotated and heated to about 190 degrees C. (about 375 degrees Fahrenheit) to initiate the molten molding process; then permitted to cool to initiate solidification. The following mixture was then introduced into the interior of the mold to permit formation of a rigid inner layer.

Polyvinyl chloride 100 kg ((Emulsion-polymerized resin PR-415 Formosa Plastics Corp., Taiwan) (45%)

Polyvinyl chloride 50 kg (Suspension-polymerized resin

PR-D, Formosa Plastics Corp., Taiwan) (23%)

Di-isononyl phthalate 40 kg (I.N.P. Union Petrochemicals Co., Ltd.; Formosa Plastics Corp.) (18%) Plasticizer 18 kg (MAX-909, Golden Chemical Corp., Taiwan) (8.2%)

Epoxidized soybean oil 4 kg (GL-22, Golden Chemical Corp., Taiwan) (2%)

Stabilizer 4 kg (CZ-74, Golden Chemical Corp., Taiwan) (2%)

Silicone oil 2 kg (1000 cs Wacker, Germany)(1%)

Perfume 2 kg (Perfumery, China) (1%)

Pigment 100 g (PasterFC-5 Huntsman, USA; Red-B, Clariant,

Germany; Y-37, Blue-B, R-CR2, Bayer, U.K.; Carbon black #3500, Columbia Co. Ltd., USA) (0.05%)

(220.1 kg total) (100.25% total)

The mold was again rotated and heated. The mold rotation was stopped, the molded doll head was permitted to cool, and was removed from the mold. The flesh-toned, softly scented doll head had a soft, velvety-feeling “skin” texture and detailed features.

The baby head mold shape was a life-sized head, approximately 3.5×4.5×4 inches in size, with a formed-in 1 to 1.25 inch neck having an annular recession (about 3/16 inch wide and ⅛ inch deep, 90 degree corners) for housing an anchor ring for attaching the body to the neck.

The coloration of the doll head was enhanced through painting after molding of the doll head. A silicone-blended paint formulation was used to provide optimal bonding of the paint layer to the molded head.

From the foregoing, it will be observed that numerous modifications and variations can be effected without departing from the true spirit and scope of the present invention. It is to be understood that no limitation with respect to the specific examples presented is intended or should be inferred. The disclosure is intended to cover by the appended claims modifications as fall within the scope of the claims.

Each of the patents and articles cited herein is incorporated by reference. The use of the article “a” or “an” is intended to include one or more.

1. interior surface of the at least partially-solidified outer layer;
d) introducing a liquid inner layer mixture to the interior surface of the at least partially-solidified molded outer layer in the mold, said liquid inner layer mixture present in an amount sufficient to coat the interior surface of the at least partially-solidified molded outer layer of the molded durable component and comprising a second polyvinyl chloride-based thermoelastic polymer starting material, and a second plasticizer, said inner layer mixture having a durometer value of more than about 20 to about 45 on a Shore A scale at ambient temperature; and
e) rotating the mold for a time period and at a temperature sufficient to permit at least partial solidification of the inner layer mixture, forming a molded durable component having an inner layer and an outer layer.

2. The process according to claim 1 wherein said first polyvinyl chloride-based thermoelastic polymer starting material comprises about 30 to about 50 weight percent and said first plasticizer comprises about 45 to about 65 weight percent of said outer layer.

3. The process according to claim 1 wherein said second polyvinyl chloride-based thermoelastic polymer starting material comprises about 50 to about 80 weight percent and said second plasticizer comprises about 20 to about 40 weight percent of said inner layer.

4. The process according to claim 1 wherein said first plasticizer is a di-C₇ to C₁₂ alkanyl phthalate.

5. The process according to claim 1 wherein said second plasticizer includes a di-C₇ to C₁₂ alkanyl phthalate.

6. The process according to claim 1 wherein a silicone oil of about 500 to about 3000 cs is present in one or both of said layers and constitutes about 0.1 to about 5 weight percent of a layer in which it is present.

7. A process for manufacturing a molded durable component having an inner layer and an outer layer comprising the steps of:
a) providing a rotational mold for a durable component, said mold having one or more interior surfaces defining a mold cavity, and an outside, the one or more interior surfaces having features that define the shape of the molded durable component;
b) introducing an outer layer mixture in liquid form into the mold cavity, the outer layer mixture being present in an amount sufficient to coat the one or more interior surfaces, said outer layer mixture comprising about 30 to about 50 weight percent of a first polyvinyl chloride-based thermoelastic polymer and about 45 to about 65 weight percent of a first plasticizer that comprises a di-C₇ to C₁₂ alkanyl phthalate, said outer layer mixture having a durometer value of about 10 to about 30 on a Shore A scale at ambient temperature;
c) rotating the mold at a speed sufficient to coat the one or more interior mold surfaces for a time period and at a temperature sufficient to permit at least partial solidification of the outer layer mixture to form an at least partially-solidified molded outer layer having an outer surface in contact with the one or more interior surfaces, said at least partial solidification being sufficient to retain the shape of the molded durable component and to define an interior surface of the at least partially-solidified outer layer; d) introducing a liquid inner layer mixture to the interior surface of the at least partially-solidified molded outer layer in the mold, said liquid inner layer mixture present in an amount sufficient to coat the interior surface of the at least partially-solidified molded outer layer of the molded durable component comprising a second polyvinyl chloride-based thermoelastic polymer that comprises about 50 to about 80 weight percent of the inner layer, and a second plasticizer that comprises about 20 to about 40 weight percent of said inner layer and includes a di-C₇ to C₁₂ alkanyl phthalate, said inner layer mixture having a durometer value of more than about 20 to about 45 on a Shore A scale at ambient temperature;
e) rotating the mold for a time period and at a temperature sufficient to permit at least partial solidification of the inner layer mixture, forming a molded durable component having an inner layer and an outer layer.

8. The process according to claim 7 wherein said first polyvinyl chloride-based thermoelastic polymer comprises an emulsion polymer.

9. The process according to claim 7 wherein said second polyvinyl chloride-based thermoelastic polymer is a mixture of polyvinyl chloride polymers.

10. The process according to claim 9 wherein said mixture of polyvinyl chloride polymers includes an emulsion and a suspension polymer.

11. The process according to claim 7 wherein said second plasticizer is a mixture of plasticizers.

12. The process according to claim 7 wherein said durable component is a doll component.

13. The process according to claim 7 wherein said outer layer mixture has a durometer value of about 10 to about 20 on a Shore A scale.

14. The process according to claim 7 wherein said inner layer mixture has a durometer value of greater than about 20 to about 35 on a Shore A scale.

15. A process for manufacturing a molded doll component having an inner layer and an outer layer comprising the steps of:
a) providing a rotational mold for a durable component, said mold having one or more interior surfaces defining a mold cavity, and an outside, the one or more surfaces having features that define the shape of the molded doll component;
b) introducing an outer layer mixture in liquid form into the mold cavity, the outer layer mixture being present in an amount sufficient to coat the one or more interior surfaces but less than an amount sufficient to completely fill the mold cavity, said, said outer layer mixture having a durometer value of about 10 to about 20 on a Shore A scale at ambient temperature and comprising:
i. about 30 to about 50 weight percent of a first polyvinyl chloride-based thermoelastic polymer, and
ii. about 45 to about 65 weight percent first plasticizer;
c) rotating the mold at a speed sufficient to coat the one or more interior mold surfaces for a time period and at a temperature sufficient to permit at least partial solidification of the outer layer mixture to form an at least partially-solidified molded outer layer having an outer surface in contact with the one or more interior surfaces, said at least partial solidification being sufficient to retain the shape of the molded doll component and to define an interior surface of the at least partially-solidified outer layer;
d) introducing a liquid inner layer mixture to the interior surface of the at least partially-solidified molded outer layer in the mold, said liquid inner layer mixture present in an amount sufficient to coat the interior surface of the at least partially-solidified molded outer layer of the molded doll component, said inner layer mixture having a durometer value of greater than 20 to about 35 on a Shore A scale at ambient temperature and comprising:
i. 50 to about 80 weight percent of a second polyvinyl chloride-based thermoelastic polymer, and
ii. a second plasticizer that comprises about 20 to about 40 weight percent; and
e) rotating the mold for a time period and at a temperature sufficient to permit at least partial curing of the inner layer mixture, forming a molded doll component having an inner layer and an outer layer.

16. The process according to claim 15 wherein said first plasticizer is a di-C₇ to C₁₂ alkanyl phthalate.

17. The process according to claim 16 wherein said di-C₇ to C₁₂ alkanyl phthalate is di-isononyl phthalate.

18. The process according to claim 15 wherein said second plasticizer is a mixture that includes a di-C₁ to C₁₂ alkanyl phthalate.

19. The process according to claim 18 wherein said di-C₇ to C₁₂ alkanyl phthalate is di-isononyl phthalate.

20. The process according to claim 15 wherein the liquid outer layer mixture additionally comprises about 0.1 to about 5 weight percent silicone oil of about 500 to about 3000 cs and the liquid inner layer mixture liquid further comprises about 0.5 to about 5 weight percent silicone oil of about 500 to about 3000 cs.

21. The process according to claim 15 wherein said first polyvinyl chloride-based thermoelastic polymer starting material is present at about 35 to about 45 weight percent.

22. The process according to claim 15 wherein said first plasticizer is present at about 50 to about 60 weight percent.

23. The process according to claim 15 wherein said second polyvinyl chloride-based thermoelastic polymer is present at about 55 to about 75 weight percent.

24. The process according to claim 15 wherein said second plasticizer is a mixture of plasticizers present at about 20 to about 35 weight percent.

25. The process according to claim 15 wherein the mold is rotated prior to initiating the solidification of the polymer outer layer.

26. (canceled)

27. A doll comprising a component manufactured according to the process of claim 15.

28. A process for manufacturing a molded durable component comprising the steps of:
a) providing a rotational mold for a durable component, said mold having one or more interior surfaces defining a mold cavity, and an outside, the one or more interior surfaces having features that define the shape of the molded durable component;
b) introducing a layer mixture in liquid form into the mold cavity, the layer mixture being present in an amount sufficient to coat the one or more interior surfaces, said layer mixture comprising a polyvinyl chloride-based thermoelastic polymer, and a plasticizer, said layer mixture having a durometer value of about 10 to about 45 on a Shore A scale at ambient temperature;
c) rotating the mold at a speed sufficient to coat the one or more interior mold surfaces for a time period and at a temperature sufficient to permit at least partial solidification of the layer mixture to form an at least partially-solidified molded layer having an outer surface in contact with the one or more interior surfaces of the mold, said at least partial solidification being sufficient to retain the shape of the molded durable component and to define an interior surface of the at least partially-solidified layer thereby forming a molded durable component.

29. The process according to claim 28 wherein said polyvinyl chloride-based thermoelastic polymer starting material comprises about 30 to about 80 weight percent and said plasticizer comprises about 20 to about 65 weight percent of said layer.

30. The process according to claim 28 wherein said plasticizer is a di-C₇ to C₁₂ alkanyl phthalate.

31. The process according to claim 28 wherein a silicone oil of about 500 to about 3000 cs is present in said layer and constitutes about 0.1 to about 5 weight percent of said layer.

32-33. (canceled)

34. A process for manufacturing a molded durable component having a single layer comprising the steps of:
a) providing a rotational mold for a durable component, said mold having one or more interior surfaces defining a mold cavity, and an outside, the one or more interior surfaces of the mold having features that define the shape of the molded durable component;
(b) introducing a liquid mixture into the mold cavity, the layer mixture being present in an amount sufficient to coat the one or more interior surfaces, and comprising a polyvinyl chloride-based thermoelastic polymer and a plasticizer, said mixture having a durometer value of about 10 to about 45 on a Shore A scale at ambient temperature after solidification;
(c) rotating the mold at a speed sufficient to coat the one or more interior mold surfaces for a time period and at a temperature sufficient to permit at least partial solidification of the mixture to form an at least partially-solidified molded durable component having an outer surface in contact with the one or more interior surfaces of the mold, said at least partial solidification being sufficient for to retain the shape of the molded durable component and to define an interior surface of the at least partially-solidified mixture thereby forming a molded durable component.

35. The process according to claim 34 wherein said polyvinyl chloride-based thermoelastic polymer starting material comprises about 30 to about 80 weight percent and said plasticizer comprises about 20 to about 65 weight percent of said liquid mixture and durable component.

36. The process according to claim 34 wherein said plasticizer is a di-C₇ to C₁₂ alkanyl phthalate.

37. The process according to claim 34 wherein a silicone oil of about 500 to about 3000 cs constitutes about 0.1 to about 5 weight percent of said liquid mixture and durable component.
